(19) United States
(12) Patent Application Publication
(10) Pub. No.: US 2024/0428379 A1
(43) Pub. Date: Dec. 26, 2024

(54) IMAGE PROCESSING APPARATUS, IMAGE PROCESSING METHOD, AND PROGRAM

(71) Applicant: FUJIFILM Corporation, Tokyo (JP)

(72) Inventor: Yasuhiko KANEKO, Kanagawa (JP)

(73) Assignee: FUJIFILM Corporation, Tokyo (JP)

(21) Appl. No.: 18/827,822

(22) Filed: Sep. 8, 2024

Related U.S. Application Data
(63) Continuation of application No. PCT/JP2022/046733, filed on Dec. 19, 2022.

(30) Foreign Application Priority Data
Mar. 17, 2022 (JP) 2022-043029

(51) Int. Cl. G06T 5/50; G06T 5/10; G06T 5/20; G06V 10/44; G06V 10/56

(52) U.S. Cl. CPC G06T 5/50; G06T 5/10; G06T 5/20; G06V 10/44; G06V 10/56; G06T 2207/20221

(57) ABSTRACT

An image processing apparatus includes a processor, and the processor is configured to make a determination whether or not imaging targets are included in generation target images used for generation of a composite image among a plurality of images obtained by imaging the imaging targets from a plurality of positions and feature information required for the generation satisfies a predetermined condition, and perform frequency emphasis processing on the generation target images in a case where the feature information satisfies the predetermined condition. The determination and the frequency emphasis processing are iterated until the feature information does not satisfy the predetermined condition.

### CROSS-REFERENCE TO RELATED APPLICATIONS

This application is a continuation application of International Application No. PCT/JP2022/046733, filed on Dec. 19, 2022, which is incorporated herein by reference in its entirety. Further, this application claims priority from Japanese Patent Application No. 2022-043029, filed on Mar. 17, 2022, the disclosure of which is incorporated by reference herein in their entirety.

### BACKGROUND

### Technical Field

A disclosed technology relates to an image processing apparatus, an image processing method, and a non-transitory computer-readable storage medium storing a program.

### Related Art

JP1996-131403A (JP-H08-131403A) discloses a medical use image processing apparatus. The medical use image processing apparatus includes a storage unit that stores first three-dimensional image data and second three-dimensional image data related to the same subject and the same site, a feature point extraction unit that extracts at least three feature points from each of the first three-dimensional image data and the second three-dimensional image data, and a coordinate transformation unit that performs coordinate transformation on at least one of the first three-dimensional image data or the second three-dimensional image data such that coordinates of feature points of the first three-dimensional image data and coordinates of corresponding feature points of the second three-dimensional image data are approximated to each other.

JP2011-141829A discloses an image processing apparatus. The image processing apparatus comprises a restoration processing unit that restores an input image by a restoration filter using a blurriness parameter. The image processing apparatus includes an image analysis unit that calculates edge intensity for each pixel of an input image, and extracts, as a feature point, a point at which the edge intensity exceeds a pre-processing threshold value and, as a non-feature point, a point at which the edge intensity does not exceed the pre-processing threshold value, and a blurriness parameter determination unit that determines a blurriness parameter such that the number of non-feature points at which the edge intensity after restoration filter processing is equal to or more than a post-processing threshold value is minimized by changing a value of the blurriness parameter.

JP2007-206738A discloses an imaging apparatus. The imaging apparatus includes an optical system that is formed such that the amount of blurriness of a focal point is substantially constant at a focusing position and a distance before and after the focusing position, an imaging element that images a subject image passing through the optical system, a transformation unit that generates an image signal obtained by correcting the blurriness of the focal point of the image from the imaging element to restore the image, and a digital filter corresponding to a subject condition used in the transformation unit. In a case where the imaged subject image has a feature point of an information code, the transformation unit performs blurriness restoration processing by selecting a digital filter to be adapted to the feature point.

### SUMMARY

One embodiment according to the disclosed technology provides an image processing apparatus, an image processing method, and a non-transitory computer-readable storage medium storing a program that can suppress a defect in a composite image in a case where the composite image is generated.

A first aspect according to the disclosed technology is an image processing apparatus comprising a processor, and the processor is configured to make a determination whether or not imaging targets are included in generation target images used for generation of a composite image among a plurality of images obtained by imaging the imaging targets from a plurality of positions and feature information required for the generation satisfies a predetermined condition, and perform frequency emphasis processing on the generation target images in a case where the feature information satisfies the predetermined condition. The determination and the frequency emphasis processing are iterated until the feature information does not satisfy the predetermined condition.

In accordance with a second aspect according to the disclosed technology, in the image processing apparatus according to the first aspect, the processor is configured to determine whether or not the feature information satisfies the predetermined condition based on imaging target information, which is information related to a characteristic of the imaging target.

In accordance with a third aspect according to the disclosed technology, in the image processing apparatus according to the second aspect, the imaging target information includes information indicating a type, a color, a material, and/or a surface state of the imaging target.

In accordance with a fourth aspect according to the disclosed technology, in the image processing apparatus according to any one of the first aspect to the third aspect, the feature information includes a first value based on the number of feature points included in the generation target image.

In accordance with a fifth aspect according to the disclosed technology, in the image processing apparatus according to the fourth aspect, the first value is the number of feature points included in an image indicating an overlap region, which is a region in which parts of the imaging targets overlap in the generation target image, or a density of the feature points.

In accordance with a sixth aspect according to the disclosed technology, in the image processing apparatus according to the fourth aspect or the fifth aspect, the predetermined condition is a condition in which the first value is equal to or less than a second value, which is a predetermined value.

In accordance with a seventh aspect according to the disclosed technology, in the image processing apparatus according to the sixth aspect, the second value is determined according to the imaging target.

In accordance with an eighth aspect according to the disclosed technology, in the image processing apparatus according to any one of the first aspect to the seventh aspect, the frequency emphasis processing is processing including a convolution operation using a mask filter.

In accordance with a ninth aspect according to the disclosed technology, in the image processing apparatus according to any one of the first aspect to the eighth aspect, the frequency emphasis processing is processing including performing Fourier transform and performing inverse Fourier transform on data from which noise is removed based on a result of the Fourier transform.

In accordance with a tenth aspect according to the disclosed technology, in the image processing apparatus according to any one of the first aspect to the ninth aspect, a parameter used in the frequency emphasis processing is set according to the imaging target.

In accordance with an eleventh aspect according to the disclosed technology, in the image processing apparatus according to any one of the first aspect to the tenth aspect, the processor is configured to determine whether or not the feature information satisfies the predetermined condition under a condition in which a signal indicating a start instruction is input, and the start instruction is received by a reception device.

In accordance with a twelfth aspect according to the disclosed technology, in the image processing apparatus according to any one of the first aspect to the eleventh aspect, the composite image includes a two-dimensional image and/or a three-dimensional image.

A thirteenth aspect according to the disclosed technology is an image processing method comprising making a determination whether or not imaging targets are included in generation target images used for generation of a composite image among a plurality of images obtained by imaging the imaging targets from a plurality of positions and feature information required for the generation satisfies a predetermined condition, and performing frequency emphasis processing on the generation target images in a case where the feature information satisfies the predetermined condition. The determination and the frequency emphasis processing are iterated until the feature information does not satisfy the predetermined condition.

A fourteenth aspect according to the disclosed technology is a non-transitory computer-readable storage medium storing a program causing a computer to execute a process of making a determination whether or not imaging targets are included in generation target images used for generation of a composite image among a plurality of images obtained by imaging the imaging targets from a plurality of positions and feature information required for the generation satisfies a predetermined condition, and performing frequency emphasis processing on the generation target images in a case where the feature information satisfies the predetermined condition. The determination and the frequency emphasis processing are iterated until the feature information does not satisfy the predetermined condition.

### BRIEF DESCRIPTION OF THE DRAWINGS

FIG. 1 is a perspective view illustrating an example of a flight imaging apparatus.

FIG. 2 is a block diagram illustrating an example of a hardware configuration of an imaging apparatus.

FIG. 3 is a block diagram illustrating an example of a functional configuration of the imaging apparatus.

FIG. 4 is an explanatory diagram for describing an example of imaging processing in a processor.

FIG. 5 is an explanatory diagram for describing an example of the imaging processing in the processor.

FIG. 6 is an explanatory diagram for describing an example of feature determination processing in the processor.

FIG. 7 is an explanatory diagram for describing an example of frequency emphasis processing in the processor.

FIG. 8 is an explanatory diagram for describing an example of image combining processing in the processor.

FIG. 9 is a flowchart for describing an example of a flow of image processing.

FIG. 10 is an explanatory diagram for describing an example of frequency emphasis processing according to Modification Example 1.

FIG. 11 is an explanatory diagram for describing an example of feature determination processing according to Modification Example 2.

FIG. 12 is an explanatory diagram for describing an example of frequency emphasis processing according to Modification Example 3.

FIG. 13 is an explanatory diagram for describing an example of a composite image according to Modification Example 4.

FIG. 14 is an explanatory diagram for describing an example of image combining processing according to a modification example.

### DETAILED DESCRIPTION

An example of an embodiment of an image processing apparatus, an image processing method, and a program according to the disclosed technology will be hereinafter described with reference to the accompanying drawings.

First, the terms used in the following description will be described.

I/F is an abbreviation for “interface”. RAM is an abbreviation for “random access memory”. EEPROM is an abbreviation for “electrically erasable programmable read-only memory”. CPU is an abbreviation for “central processing unit”. HDD is an abbreviation for “hard disk drive”. SSD is an abbreviation for “solid state drive”. DRAM is an abbreviation for “dynamic random access memory”. SRAM is an abbreviation for “static random access memory”. CMOS is an abbreviation for “complementary metal oxide semiconductor”. GPU is an abbreviation for “graphics processing unit”. TPU is an abbreviation for “tensor processing unit”. USB is an abbreviation for “universal serial bus”. ASIC is an abbreviation for “application specific integrated circuit”. FPGA is an abbreviation for “field-programmable gate array”. PLD is an abbreviation for “programmable logic device”. SoC is an abbreviation for “system-on-a-chip”. IC is an abbreviation for “integrated circuit”. AI is an abbreviation for “artificial intelligence”.

In the description of the present specification, the term “perpendicular” indicates perpendicular in the sense of including an error generally allowed in the technical field, to which the disclosed technology belongs, that is, an error that does not contradict the gist of the disclosed technology, in addition to completely perpendicular. In the description of the present specification, the term “coincidence” indicates coincidence in the sense of including an error generally allowed in the technical field, to which the disclosed technology belongs, that is, an error that does not contradict the gist of the disclosed technology, in addition to complete coincidence. In the description of the present specification, the term “equal” indicates equal in the sense of including an error generally allowed in the technical field, to which the disclosed technology belongs, that is, an error that does not contradict the gist of the disclosed technology, in addition to completely equal. In the description of the present specification, the term “horizontal direction” indicates a horizontal direction in the sense of including an error generally allowed in the technical field to which the disclosed technology belongs, that is, an error that does not contradict the gist of the disclosed technology, in addition to a complete horizontal direction. In the description of the present specification, the term “vertical direction” indicates a vertical direction in the sense of including an error generally allowed in the technical field to which the disclosed technology belongs, that is, an error that does not contradict the gist of the disclosed technology, in addition to a complete vertical direction.

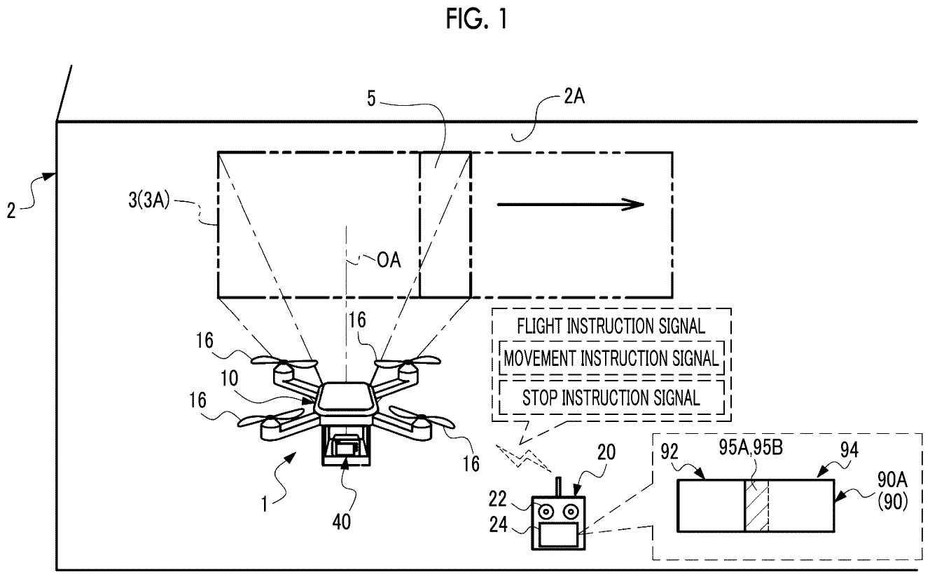

For example, as illustrated in FIG. 1, a flight imaging apparatus 1 comprises a flight function and an imaging function, and images a wall surface 2A of an imaging target 2 while flying. In the description of the present specification, the concept of “flight” includes not only the meaning that the flight imaging apparatus 1 moves in the air but also the meaning that the flight imaging apparatus 1 is stopped in the air. The imaging target 2 is an example of an “imaging target” according to the disclosed technology.

The wall surface 2A is, for example, a plane. The plane refers to a two-dimensional surface (that is, a surface along a two-dimensional direction). In addition, in the description of the present specification, the concept of “plane” does not include the meaning of a mirror surface. In the present embodiment, for example, the wall surface 2A is a plane defined in a horizontal direction and a vertical direction (that is, a surface extending in the horizontal direction and the vertical direction). For example, the imaging target 2 having the wall surface 2A is a bridge pier provided in a bridge. The bridge pier is made of, for example, reinforced concrete. Here, examples of the imaging target 2 include the bridge pier, but the imaging target 2 may be a thing other than the bridge pier (for example, a tunnel or a dam).

The flight function of the flight imaging apparatus 1 (hereinafter, also simply referred to as the “flight function”) is a function of the flight imaging apparatus 1 flying based on a flight instruction signal. The flight instruction signal refers to a signal for instructing the flight imaging apparatus 1 to fly. The flight instruction signal is transmitted from, for example, a transmitter 20 for operating the flight imaging apparatus 1. The transmitter 20 is operated by a user (not illustrated). The transmitter 20 comprises an operation unit 22 for operating the flight imaging apparatus 1, and a display device 24 for displaying an image obtained by being imaged by the flight imaging apparatus 1. The display device 24 is, for example, a liquid crystal display.

Specifically, the flight instruction signal is classified into a plurality of instruction signals including a movement instruction signal for giving an instruction about movement and a movement direction of the flight imaging apparatus 1 and a stop instruction signal for giving an instruction about stopping of the flight imaging apparatus 1. Here, although the example in which the flight instruction signal is transmitted from the transmitter 20 has been described, the flight instruction signal may be transmitted from a base station (not illustrated) or the like that sets a flight route for the flight imaging apparatus 1. The imaging function of the flight imaging apparatus 1 (hereinafter, also simply referred to as the “imaging function”) is a function of the flight imaging apparatus 1 imaging a subject (for example, the wall surface 2A of the imaging target 2).

The flight imaging apparatus 1 comprises a flying object 10 and an imaging apparatus 30. The flying object 10 is, for example, an unmanned aerial vehicle such as a drone. The flight function is realized by the flying object 10. The flying object 10 includes a plurality of propellers 12, and flies by rotating the plurality of propellers 12.

The imaging apparatus 30 is mounted on the flying object 10. Examples of the imaging apparatus 30 include a digital camera. The imaging function is realized by the imaging apparatus 30. The imaging apparatus 30 is provided in a lower part of the flying object 10. Here, although an example in which the imaging apparatus 30 is provided in the lower part of the flying object 10 has been described, the imaging apparatus 30 may be provided in an upper part, a front part, or the like of the flying object 10. The imaging apparatus 30 is an example of an “image processing apparatus” according to the disclosed technology.

The flight imaging apparatus 1 sequentially images a plurality of regions 3 of the wall surface 2A. The region 3 is a region determined by an angle of view of the flight imaging apparatus 1. In the example illustrated in FIG. 1, a quadrangular region is illustrated as an example of the region 3. A plurality of generation target images 92 and 94 are obtained by sequentially imaging the plurality of regions 3 with the imaging apparatus 30. A composite image 90 is generated by combining the plurality of generation target images 92 and 94. The plurality of generation target images 92 and 94 are combined such that parts of adjacent generation target images 92 and 94 overlap with each other. The composite image 90 is used, for example, for inspecting or surveying the wall surface 2A of the imaging target 2. In the example illustrated in FIG. 1, the composite image 90 is a two-dimensional image 90A. The composite image 90 is an example of a “composite image” according to the disclosed technology, and the two-dimensional image 90A is an example of a “two-dimensional image” according to the disclosed technology.

In the example illustrated in FIG. 1, an aspect in which each region 3 is imaged by the imaging apparatus 30 in a state where an optical axis OA of the imaging apparatus 30 is perpendicular to the wall surface 2A is illustrated. The plurality of regions 3 are imaged such that parts of the adjacent regions 3 overlap with each other. The reason why the plurality of regions 3 are imaged such that parts of the adjacent regions 3 overlap with each other is to generate the composite image 90 corresponding to the adjacent regions 3 based on feature points included in the overlapping portion of the adjacent regions 3.

Hereinafter, a case where parts of the adjacent regions 3 overlap with each other is referred to as an overlap, and a region where the adjacent regions 3 overlap with each other is referred to as an overlap region 5. In addition, a ratio of an area of the overlap region 5 to the entire area of the region 3 is referred to as an overlap ratio. The overlap ratio is set to a rate at which the amount of the feature points that can be used to generate the composite image 90 is obtained. The overlap ratio is set, for example, in a range in which a defect does not occur in the composite image 90 based on the result of the generation of the composite image 90, but this setting is merely an example. The overlap ratio may be set to a predetermined overlap ratio (for example, 30%).

The generation target image 92 has an overlap image region 95A, which is an image region indicating the overlap region 5. In addition, the generation target image 94 has an overlap image region 95B, which is an image region indicating the overlap region 5. The composite image 90 is generated by combining the overlap image regions 95A and 95B.

In the example illustrated in FIG. 1, the plurality of regions 3 include an already imaged region 3 (that is, a region 3 imaged by the flight imaging apparatus 1) and an unimaged region 3 (that is, a region 3 to be imaged by the flight imaging apparatus 1). Hereinafter, in a case where the plurality of regions 3 are described in a distinguishable manner, the unimaged region 3 among the plurality of regions 3 is referred to as an “imaging target region 3A”, and the already imaged region 3 among the plurality of regions 3 is referred to as an “imaged region 3B”.

The flight imaging apparatus 1 images the plurality of regions 3 while moving, for example, in the horizontal direction. In addition, the flight imaging apparatus 1 images the plurality of regions 3 in the order in which a part of the imaging target region 3A and a part of the imaged region 3B, which is imaged one before the imaging target region 3A (for example, which is imaged in one frame before) overlap with each other. Hereinafter, for example, as illustrated in FIG. 1, description will be made on the assumption that the plurality of regions 3 are imaged by the flight imaging apparatus 1 moving in the horizontal direction, but this case is merely an example. For example, the flight imaging apparatus 1 may image the plurality of regions 3 while moving in a zigzag manner by alternately repeating the movement in the horizontal direction and the movement in the vertical direction.

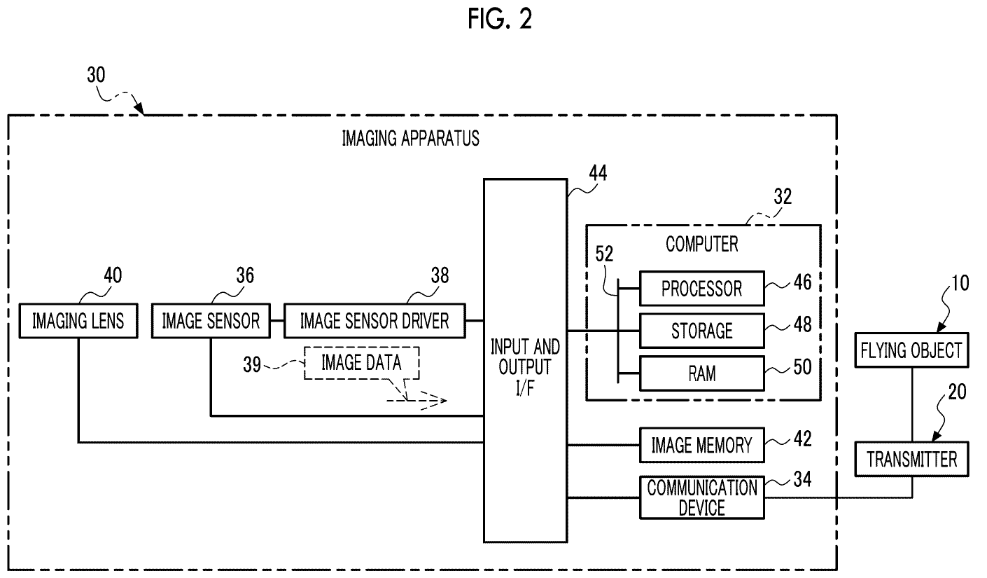

For example, as illustrated in FIG. 2, the imaging apparatus 30 comprises a computer 32, a communication device 34, an image sensor 36, an image sensor driver 38, an imaging lens 40, an image memory 42, and an input and output I/F 44.

The computer 32 comprises a processor 46, a storage 48, and a RAM 50. The processor 46, the storage 48, and the RAM 50 are connected to each other via a bus 52, and the bus 52 is connected to the input and output I/F 44. In addition, the communication device 34, the image sensor driver 38, the imaging lens 40, and the image memory 42 are connected to the input and output I/F 44. The computer 32 is an example of a “computer” according to the disclosed technology. The processor 46 is an example of a “processor” according to the disclosed technology.

The processor 46 includes, for example, a CPU, and controls the entire imaging apparatus 30. The storage 48 is a nonvolatile storage device that stores various programs, various parameters, and the like. Examples of the storage 48 include an HDD and/or a flash memory (for example, an EEPROM and/or an SSD).

The RAM 50 is a memory where information is temporarily stored, and is used as a work memory by the processor 46. Examples of the RAM 50 include a DRAM and/or an SRAM.

For example, the communication device 34 is connected to communicate with the transmitter 20. Here, the communication device 34 is connected to wirelessly communicate with the transmitter 20 by a predetermined wireless communication standard. Examples of the predetermined wireless communication standard include Wi-Fi (registered trademark). The communication device 34 controls the transmission and reception of information to and from the transmitter 20. For example, the communication device 34 transmits, to the transmitter 20, information in response to a request from the processor 46. In addition, the communication device 34 receives information transmitted from the transmitter 20, and outputs the received information to the processor 46 via the bus 52. Here, although the example in which the communication device 34 is connected to communicate with the transmitter 20 has been described, the communication device 34 may be connected to communicate with the transmitter 20 and/or the flying object 10.

The image sensor 36 is connected to the image sensor driver 38. The image sensor driver 38 controls the image sensor 36 in accordance with an instruction from the processor 46. The image sensor 36 is, for example, a CMOS image sensor. It should be noted that, here, although an example in which the image sensor 36 is the CMOS image sensor has been described, the disclosed technology is not limited thereto, and other image sensors may be used. The image sensor 36 images the subject (for example, the wall surface 2A of the imaging target 2) under the control of the image sensor driver 38, and outputs image data obtained by the imaging.

The imaging lens 40 is disposed on a subject side (for example, an object side) with respect to the image sensor 36. The imaging lens 40 takes in subject light, which is reflected light from the subject, and forms an image of the taken-in subject light on the imaging surface of the image sensor 36. The imaging lens 40 includes a plurality of optical elements (not illustrated) such as a focus lens, a zoom lens, and a stop. The imaging lens 40 is connected to the computer 32 via the input and output I/F 44. Specifically, the plurality of optical elements included in the imaging lens 40 are connected to the input and output I/F 44 via a driving mechanism (not illustrated) having a power source. The plurality of optical elements included in the imaging lens 40 operate under the control of the computer 32. In the imaging apparatus 30, a focus, an optical zoom, a shutter speed, and the like are realized by operating the plurality of optical elements included in the imaging lens 40.

The image data generated by the image sensor 36 is temporarily stored in the image memory 42. The processor 46 acquires image data 39 from the image memory 42 and executes various kinds of processing by using the acquired image data 39.

As described above, in a case where the composite image 90 is generated, the composite image 90 is generated based on the feature points included in the overlapping portion (that is, the overlap region 5) of the adjacent regions 3. However, in some cases, the imaging target 2 may have a flat surface with little unevenness and/or little change in color (for example, a flat wall surface of a white bridge pier) in a plane that is a target of the imaging. In such a case, since the number of feature amounts required for the generation of the composite image 90 is reduced, the generated composite image 90 may be defective.

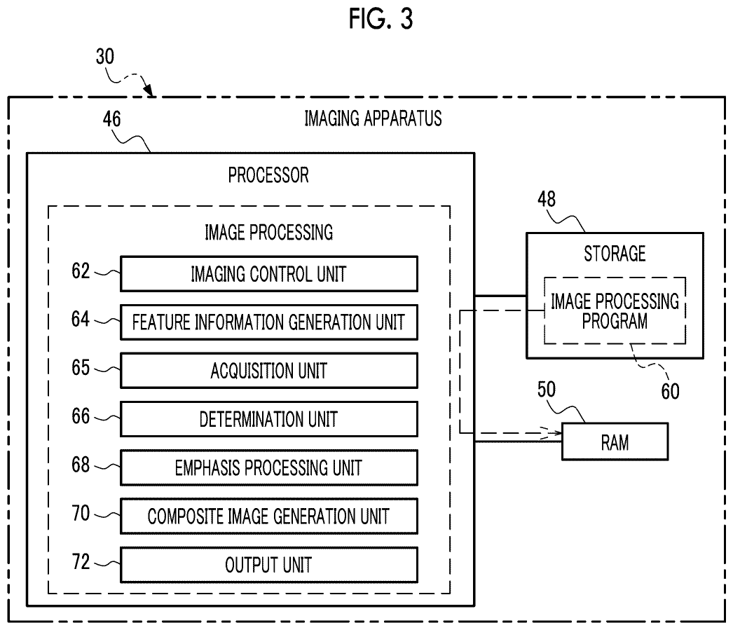

Therefore, in view of these circumstances, in the present embodiment, for example, as illustrated in FIG. 3, the processor 46 performs image processing. In the storage 48, an image processing program 60 is stored. The image processing program 60 is an example of a “program” according to the disclosed technology. The processor 46 reads out the image processing program 60 from the storage 48 and executes the read-out image processing program 60 on the RAM 50. The processor 46 performs image processing for generating the composite image 90 without being defective, in accordance with the image processing program 60 executed on the RAM 50.

The image processing is realized by the processor 46 operating as an imaging control unit 62, a feature information generation unit 64, an acquisition unit 65, a determination unit 66, an emphasis processing unit 68, a composite image generation unit 70, and an output unit 72 in accordance with the image processing program 60.

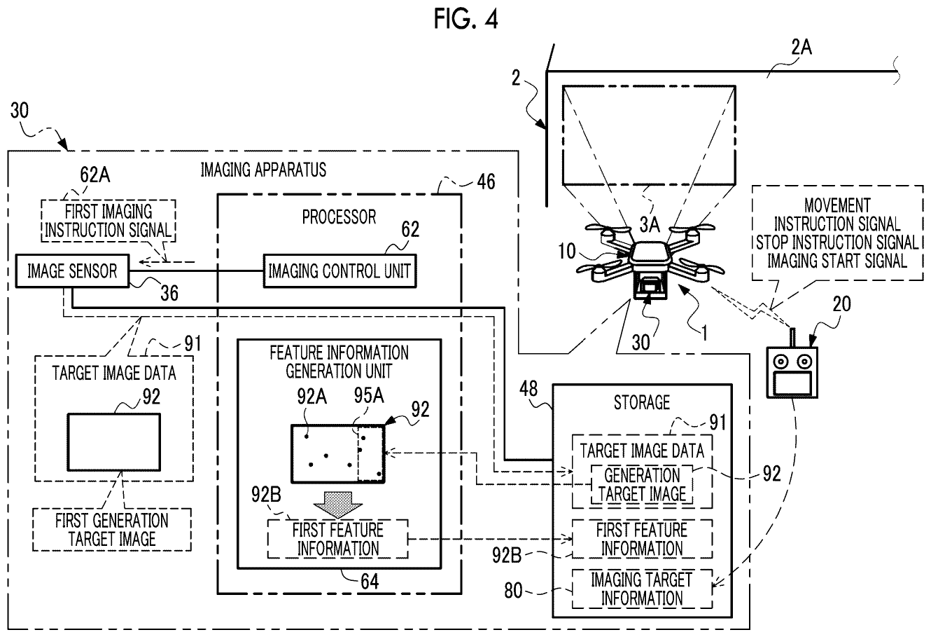

For example, as illustrated in FIG. 4, the flying object 10 receives the movement instruction signal transmitted from the transmitter 20 in response to an operation by the user, and moves to an imaging position based on the received movement instruction signal. In addition, the flying object 10 receives the stop instruction signal transmitted from the transmitter 20 in response to an operation by the user, and is stopped at an imaging position based on the received stop instruction signal. In a case where the imaging apparatus 30 receives an imaging start signal transmitted from the transmitter 20 in response to an operation by the user, the imaging apparatus 30 executes imaging processing to be described below. In addition, the flying object 10 receives imaging target information 80 transmitted from the transmitter 20 in response to an operation by the user, and stores the imaging target information 80 in the storage 48. The imaging target information 80 is information related to a characteristic of the imaging target 2. For example, the imaging target information 80 is information indicating a type of the imaging target 2 (for example, that the imaging target 2 is the bridge pier). The imaging target information 80 is an example of “imaging target information” according to the disclosed technology.

The imaging control unit 62 causes the image sensor 36 to image the imaging target region 3A by outputting a first imaging instruction signal 62A to the image sensor 36. The imaging target region 3A is imaged by the image sensor 36 under the control of the imaging control unit 62 to obtain target image data 91. The target image data 91 includes image data indicating the generation target image 92. The target image data 91 is stored in the storage 48. The target image data 91 illustrated in FIG. 4 represents the generation target image 92, which is a first composite image. The generation target image 92 is an example of a “generation target image” according to the disclosed technology. The generation target image 92 includes feature points corresponding to the unevenness, the change in color, and/or the like of the imaging target region 3A. Hereinafter, a feature point 92A included in the generation target image 92 is referred to as a “first feature point 92A”.

The feature information generation unit 64 acquires the generation target image 92 based on the target image data 91 stored in the storage 48. The feature information generation unit 64 generates first feature information 92B based on the generation target image 92. The first feature information 92B is information related to the first feature point 92A included in the generation target image 92. For example, the first feature information 92B is a value determined based on the number of first feature points 92A included in the generation target image 92. The first feature information 92B is an example of “feature information” according to the disclosed technology.

The feature information generation unit 64 extracts the first feature point 92A included in the overlap image region 95A in the generation target image 92. The feature information generation unit 64 generates first feature information 92B indicating the number N1 of extracted first feature points 92A (hereinafter, also simply referred to as a “feature point number N1”). The first feature information 92B generated by the feature information generation unit 64 is stored in the storage 48. In addition, the first feature information 92B also includes information indicating coordinates of the first feature point 92A. The coordinates of the first feature point 92A indicated by the first feature information 92B are derived, for example, by performing image processing (for example, high-frequency component extraction processing or the like) on the target image data 91. The coordinates of the first feature point 92A are, for example, coordinates based on any one of four vertices of the imaging target region 3A.

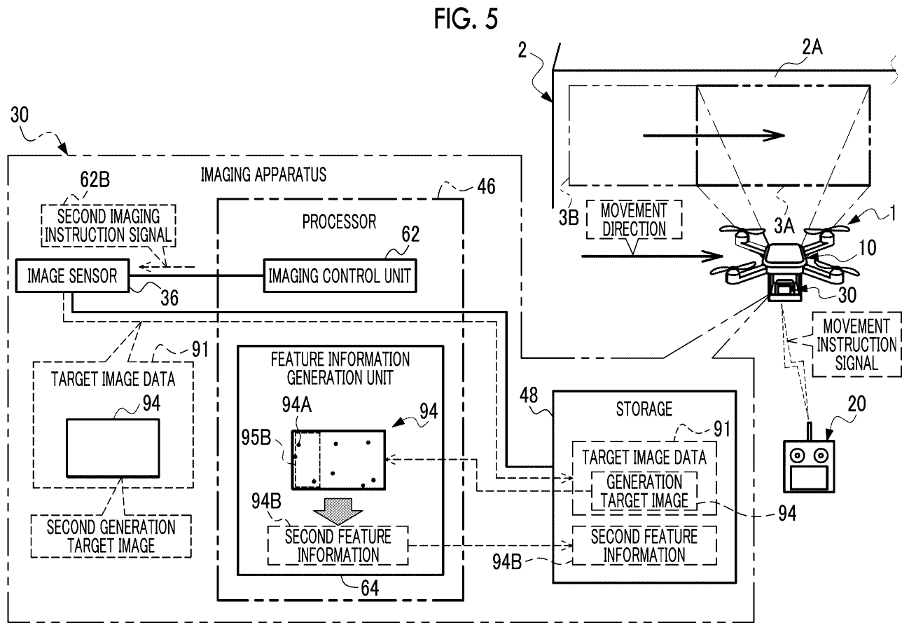

For example, as illustrated in FIG. 5, in a case where the movement instruction signal transmitted from the transmitter 20 in response to the operation by the user is received, the flying object 10 moves based on the received movement instruction signal. In the example illustrated in FIG. 5, the flying object 10 moves in the horizontal direction based on the movement instruction signal. Specifically, the movement direction of the flying object 10 is a right direction toward the wall surface 2A. The flying object 10 continues the movement based on the received movement instruction signal while receiving the movement instruction signal transmitted from the transmitter 20 in response to the operation by the user.

The imaging control unit 62 causes the image sensor 36 to image the imaging target region 3A by outputting the second imaging instruction signal 62B to the image sensor 36. The imaging target region 3A is imaged by the image sensor 36 under the control of the imaging control unit 62 to obtain target image data 91. The target image data 91 includes image data indicating the generation target image 94. The generation target image 94 is obtained by being imaged by the imaging apparatus 30 in a case where the flying object 10 moves from a position at which the generation target image 92 is obtained. The target image data 91 is stored in the storage 48. The generation target image 94 is an example of a “generation target image” according to the disclosed technology. The generation target image 94 includes feature points corresponding to the unevenness, the change in color, and/or the like of the imaging target region 3A. Hereinafter, the feature point included in the generation target image 94 is referred to as a “second feature point 94A”. In addition, in the following description, in a case where it is not necessary to distinguish between the “first feature point 92A” and the “second feature point 94A”, the first feature point 92A and the second feature point 94A are also simply referred to as the “feature point”.

In a case where the generation target image 94 is a generation target image obtained next to the generation target image 92, the feature information generation unit 64 acquires the generation target image 94 based on the target image data 91 stored in the storage 48. The second feature information 94B is information related to the second feature point 94A included in the generation target image 94. For example, the second feature information 94B is a value determined based on the number of second feature points 94A included in the generation target image 94. The second feature information 94B is an example of “feature information” according to the disclosed technology.

The feature information generation unit 64 extracts the second feature point 94A included in the overlap image region 95B of the generation target image 94. The feature information generation unit 64 generates second feature information 94B indicating the number N2 of extracted second feature points 94A (hereinafter, also simply referred to as a “feature point number N2”). The second feature information 94B generated by the feature information generation unit 64 is stored in the storage 48. It should be noted that, hereinafter, in a case where it is not necessary to distinguish between the “number N1 of first feature points 92A” and the “number N2 of second feature points 94A”, the number N1 of first feature points 92A and the number N2 of second feature points 94A are also simply referred to as the “feature point number N”. The feature point number N is an example of a “first value” according to the disclosed technology.

In addition, the second feature information 94B also includes information indicating the coordinates of the second feature point 94A. The coordinates of the second feature point 94A are derived by the same method as the coordinates of the first feature point 92A extracted by the feature information generation unit 64.

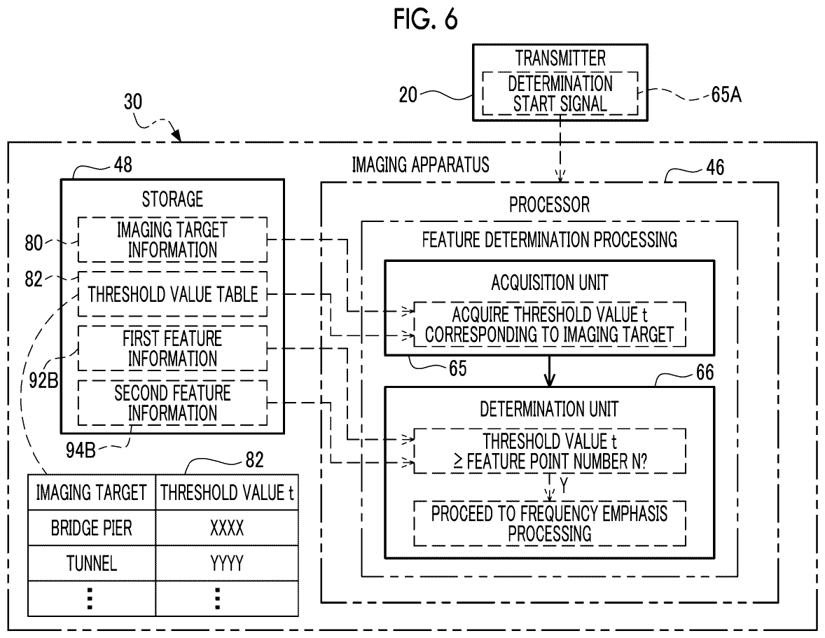

For example, as illustrated in FIG. 6, the acquisition unit 65 first acquires a determination start signal 65A output from the transmitter 20 by an operation of the user. In the acquisition unit 65, feature determination processing is started with the reception of the determination start signal 65A as a condition. The transmitter 20 is an example of a “reception device” according to the disclosed technology. The acquisition unit 65 acquires the imaging target information 80 from the storage 48. In addition, the acquisition unit 65 acquires a threshold value table 82 stored in advance in the storage 48. The threshold value table 82 is a table in which a numerical value indicating a type of the imaging target (for example, a bridge pier, a tunnel, or the like) is used as an input value and a threshold value t corresponding to the imaging target is used as an output value. The threshold value t is, for example, a numerical value indicating the number of feature points that enable the generation of the composite image 90 without the defect. The threshold value t is determined in advance based on, for example, a computer simulation, a test result by an actual machine, and/or a generation result of the past composite image 90. The acquisition unit 65 acquires the threshold value t corresponding to the imaging target indicated by the imaging target information 80 by using the threshold value table 82. The threshold value t is an example of a “second value” according to the disclosed technology.

The determination unit 66 determines whether or not the first feature information 92B satisfies a predetermined condition by executing the feature determination processing. Specifically, the determination unit 66 acquires the first feature information 92B from the storage 48. The determination unit 66 compares the threshold value t acquired by the acquisition unit 65 with the feature point number N1 indicated by the first feature information 92B. Here, in the example illustrated in FIG. 6, the condition in which the feature point number N1 is equal to or less than the threshold value t is illustrated as the predetermined condition. In a case where the feature point number N1 is equal to or less than the threshold value t, the determination unit 66 determines that the first feature information 92B satisfies the predetermined condition.

In addition, the determination unit 66 determines whether or not the second feature information 94B satisfies the predetermined condition by executing the feature determination processing. Specifically, the determination unit 66 acquires the second feature information 94B from the storage 48. The determination unit 66 compares the threshold value t acquired by the acquisition unit 65 with the feature point number N2 indicated by the second feature information 94B. Here, in the example illustrated in FIG. 6, the condition in which the feature point number N2 is equal to or less than the threshold value t is illustrated as the predetermined condition. In a case where the feature point number N2 is equal to or less than the threshold value t, the determination unit 66 determines that the second feature information 94B satisfies the predetermined condition. In a case where it is determined in the determination unit 66 that the predetermined condition is satisfied, the feature determination processing proceeds to frequency emphasis processing using the emphasis processing unit 68.

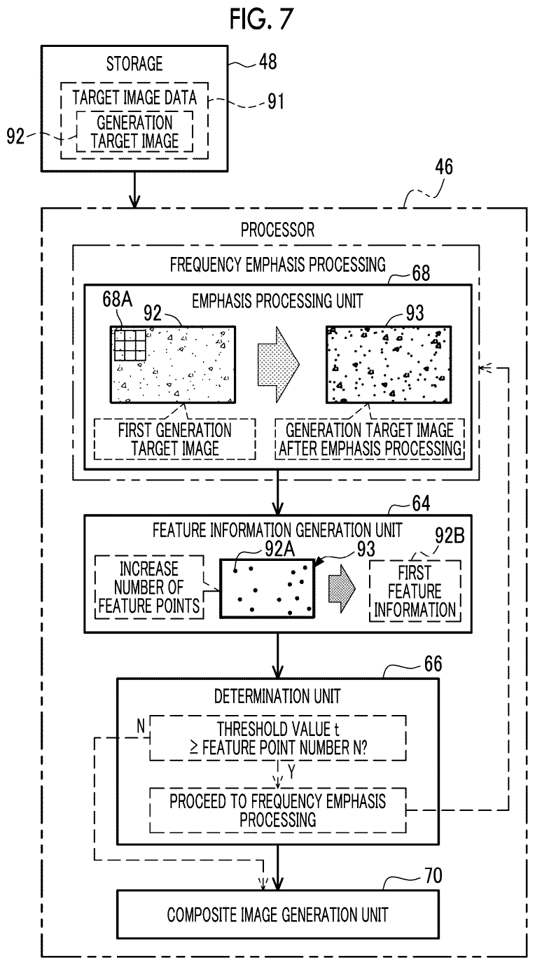

For example, as illustrated in FIG. 7, the emphasis processing unit 68 performs the frequency emphasis processing on an image that is a target of the frequency emphasis processing based on the result of the feature determination processing in the determination unit 66. In the following description of the frequency emphasis processing, although a case where the frequency emphasis processing is performed on the generation target image 92 will be described, the same processing is also performed on the generation target image 94.

The emphasis processing unit 68 acquires the generation target image 92 from the storage 48. The emphasis processing unit 68 performs the frequency emphasis processing on the generation target image 92. The frequency emphasis processing is processing of removing a low-frequency component, which is noise, and emphasizing a high-frequency component, which is a feature point. In the example illustrated in FIG. 7, as a result of convolution operation processing using a 3×3 mask filter 68A on the generation target image 92 by the emphasis processing unit 68, the generation target image 93 is obtained. It should be noted that, the 3×3 mask filter 68A is merely an example, and may be an N×N mask filter 68A (N is a natural number of 2 or more), and the number of masks is not particularly limited. The emphasis processing unit 68 outputs the generation target image 93 after the frequency emphasis processing to the feature information generation unit 64.

The feature information generation unit 64 extracts the first feature point 92A included in the generation target image 93 after the frequency emphasis processing, and generates the first feature information 92B indicating the coordinates and the number of extracted first feature point 92A. The determination unit 66 determines whether or not the first feature information 92B satisfies the predetermined condition by comparing the feature point number N1 indicated by the first feature information 92B with the threshold value t. In a case where the feature point number N1 indicated by the first feature information 92B is equal to or less than the threshold value t, the determination unit 66 determines that the predetermined condition is satisfied, and the feature determination processing proceeds to the frequency emphasis processing again.

On the other hand, in a case where the feature point number N1 indicated by the first feature information 92B is more than the threshold value t, the determination unit 66 determines that the predetermined condition is not satisfied. In this case, the feature determination processing proceeds to image combining processing in the composite image generation unit 70.

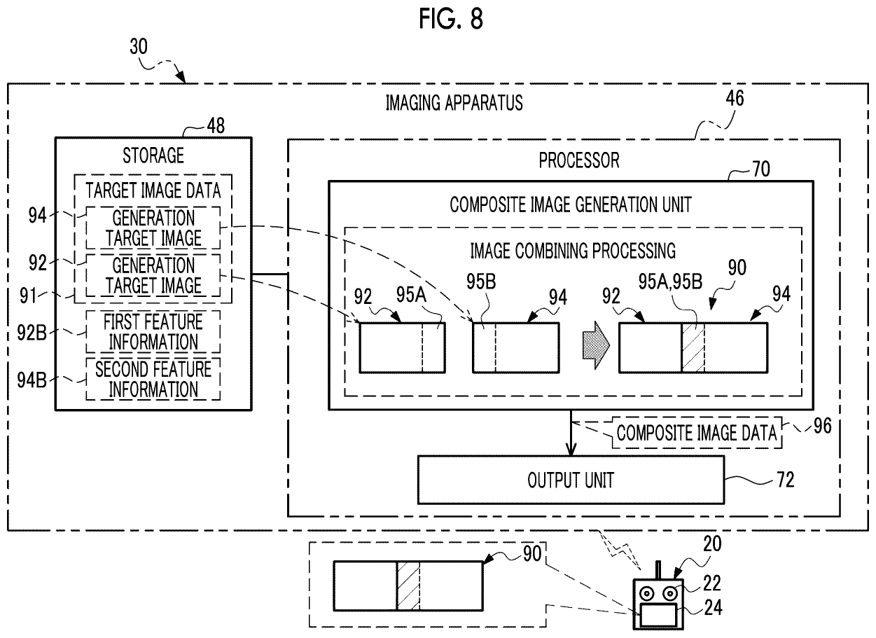

For example, as illustrated in FIG. 8, the composite image generation unit 70 acquires the generation target images 92 and 94 from the storage 48. The composite image generation unit 70 performs the image combining processing on the generation target images 92 and 94. The image combining processing is processing of generating the composite image 90 based on the first feature information 92B and the second feature information 94B. The composite image generation unit 70 generates the composite image 90 by combining the overlap image region 95A of the generation target image 92 and the overlap image region 95B of the generation target image 94 in a state of overlapping with each other. The composite image generation unit 70 outputs composite image data 96 indicating the composite image 90 to the output unit 72. The output unit 72 outputs the composite image data 96 input from the composite image generation unit 70 to the outside. In the example illustrated in FIG. 8, the output unit 72 outputs the composite image data 96 to the transmitter 20. The transmitter 20 displays the composite image 90 indicated by the composite image data 96 on the display device 24.

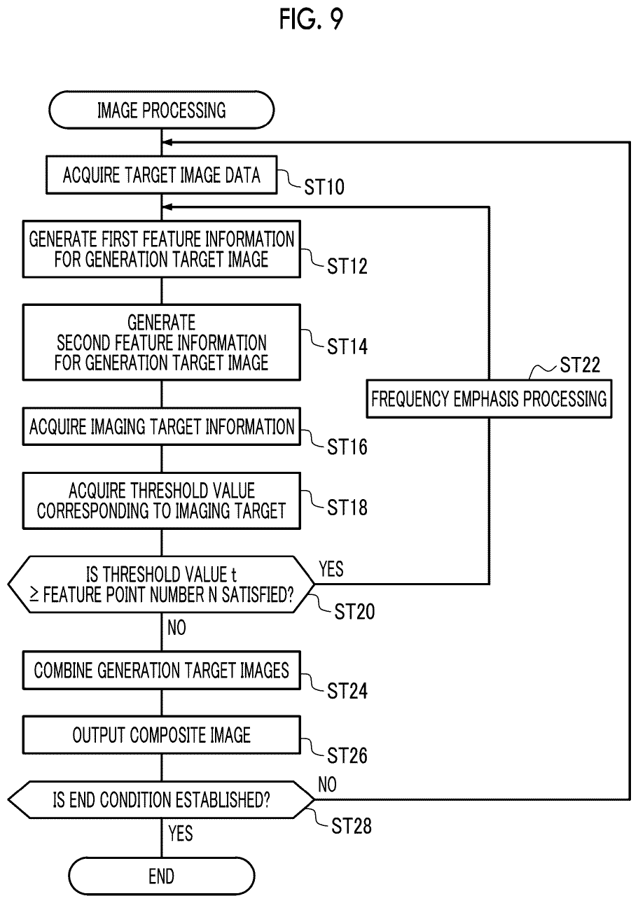

Next, an action of the flight imaging apparatus 1 according to the present embodiment will be described with reference to FIG. 9. FIG. 9 illustrates an example of a flow of the image processing according to the present embodiment. The flow of the image processing illustrated in FIG. 9 is an example of an “image processing method” according to the disclosed technology.

In the image processing illustrated in FIG. 9, first, in step ST10, the imaging target region 3A is imaged by the image sensor 36 under the control of the imaging control unit 62 to obtain the target image data 91. The target image data 91 includes pieces of data indicating the generation target images 92 and 94. The target image data 91 is stored in the storage 48. After the processing of step ST10 is executed, the image processing proceeds to step ST12.

In step ST12, the feature information generation unit 64 generates the first feature information 92B for the generation target image 92 acquired from the storage 48. After the processing of step ST12 is executed, the image processing proceeds to step ST14.

In step ST14, the feature information generation unit 64 generates the second feature information 94B for the generation target image 94 acquired from the storage 48. After the processing of step ST14 is executed, the image processing proceeds to step ST16.

In step ST16, the acquisition unit 65 acquires the imaging target information 80 from the storage 48. After the processing of step ST16 is executed, the image processing proceeds to step ST18.

In step ST18, the acquisition unit 65 acquires the threshold value t corresponding to the type of the imaging target indicated by the imaging target information 80 by using the threshold value table 82 in the storage 48. After the processing of step ST18 is executed, the image processing proceeds to step ST20.

In step ST20, the determination unit 66 determines whether or not the feature point numbers N indicated by the first feature information 92B and the second feature information 94B generated in steps ST12 and ST14, respectively, satisfy the condition in which the feature point number N is equal to or less than the threshold value t. In a case where the feature point number N is equal to or less than the threshold value t, the determination is positive, and the image processing proceeds to step ST22. In a case where the feature point number N is more than the threshold value t, the determination is negative, and the image processing proceeds to step ST24.

In step ST22, the emphasis processing unit 68 performs the frequency emphasis processing on the image on which it is determined in the determination unit 66 in step ST20 that the feature point number N is equal to or less than the threshold value t. After the processing of step ST22 is executed, the image processing returns to step ST12.

In step ST24, the composite image generation unit 70 generates the composite image 90 by combining the overlap image region 95A of the generation target image 92 and the overlap image region 95B of the generation target image 94 in a state of overlapping with each other. In other words, the composite image generation unit 70 generates the composite image 90 based on the feature point 92A indicated by the first feature information 92B and the feature point 94A indicated by the second feature information 94B. After the processing of step ST26 is executed, the image processing proceeds to step ST24.

In step ST26, the output unit 72 outputs the composite image data 96 indicating the composite image 90 generated in step ST24 to the outside. After the processing of step ST26 is executed, the image processing proceeds to step ST28.

In step ST28, the output unit 72 determines whether or not the image processing satisfies an end condition. Examples of the end condition include a condition in which the user gives an instruction to end the image processing to the imaging apparatus 30, a condition in which the number of generation target images 92 and 94 reaches the number designated by the user, and the like. In step ST28, in a case where the end condition is not established, a negative determination is made, and the image processing transitions to step ST10. In step ST28, in a case where the end condition is established, the determination is positive, and the image processing is ended.

As described above, in the flight imaging apparatus 1 according to the present embodiment, the processor 46 determines whether or not the first feature information 92B and the second feature information 94B satisfy the predetermined conditions for the generation target images 92 and 94 used for the generation of the composite image 90. Then, in a case where the first feature information 92B and the second feature information 94B satisfy the conditions, the frequency emphasis processing is performed. The frequency emphasis processing is performed, and thus, a contour of the unevenness, the change in color, or the like included, as images, in the generation target images 92 and 94 are emphasized, and the feature information is increased as compared with the feature information before the processing. The feature point numbers N indicated by the first feature information 92B and the second feature information 94B are increased, and thus, matching of the first feature information 92B and the second feature information 94B between the images used for the generation is accurately performed. Accordingly, with the present configuration, it is possible to suppress the defect of the composite image 90 in a case where the composite image 90 is generated.

For example, even in a case where the first feature information 92B and the second feature information 94B satisfy the predetermined condition in the generation of the composite image 90, in a case where the frequency emphasis processing is not performed, the feature information required for the generation of the composite image 90 is insufficient, and the generated composite image 90 is defective. In the present configuration, since the feature point numbers N indicated by the first feature information 92B and the second feature information 94B are increased by the frequency emphasis processing, the defect of the composite image 90 in a case where the composite image 90 is generated is suppressed as compared with a case where the feature point numbers N are not increased.

In addition, in the flight imaging apparatus 1 according to the present embodiment, the processor 46 determines whether or not the first feature information 92B and the second feature information 94B satisfy the predetermined conditions based on the imaging target information 80, which is the information related to the characteristic of the imaging target 2. Thus, the accuracy of the determination for sorting out the image as the target of the frequency emphasis processing is improved. As a result, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

For example, in comparison with a case where it is determined whether or not the first feature information 92B and the second feature information 94B satisfy the predetermined conditions without considering the imaging target information 80, in the present configuration, the determination for sorting out the image as the target of the frequency emphasis processing is performed after considering the imaging target information 80. In a case where the sorting accuracy is improved, the frequency emphasis processing is performed on the image for which the increase in the feature information is required. That is, the frequency emphasis processing is accurately performed. Accordingly, with the present configuration, in the generation of the composite image 90, the composite image 90 is prevented from being defective.

In addition, in the flight imaging apparatus 1 according to the present embodiment, the imaging target information 80 includes information indicating the type of the imaging target 2 (for example, the imaging target 2 is the bridge pier). In the processor 46, it is determined whether or not the first feature information 92B and the second feature information 94B satisfy the predetermined conditions based on the type of the imaging target 2. Thus, the accuracy of the determination for sorting out the image as the target of the frequency emphasis processing is improved. As a result, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

For example, in comparison with a case where the determination is performed without considering the information indicating the type of the imaging target 2 included in the imaging target information 80, in the present configuration, the determination for sorting out the image as the target of the frequency emphasis processing is performed based on the type of the imaging target 2. In a case where the sorting accuracy is improved, the frequency emphasis processing is performed on the image for which the increase in the feature information is required. That is, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

In addition, in the flight imaging apparatus 1 according to the present embodiment, the first feature information 92B and the second feature information 94B include the feature point numbers N, which are the numbers of feature points included in the generation target images 92 and 94, and the determination is performed based on the feature point number N. Thus, the accuracy of the determination for sorting out the image as the target of the frequency emphasis processing is improved. As a result, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

For example, in comparison with a case where the determination is performed without considering the feature point number N included in the generation target images 92 and 94, in the present configuration, the determination for sorting out the image as the target of the frequency emphasis processing based on the feature point number N is performed. That is, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

In addition, in the flight imaging apparatus 1 according to the present embodiment, the first feature information 92B and the second feature information 94B indicate the feature point numbers N included in the overlap region 5 of the imaging target 2. The composite image 90 is combined by overlapping the overlap image regions 95A and 95B of the generation target images 92 and 94. The frequency emphasis processing is performed, and thus, the matching of the first feature information 92B and the second feature information 94B in the overlap image regions 95A and 95B between the images used for the generation is accurately performed. Accordingly, with the present configuration, in the generation of the composite image 90, the composite image 90 is prevented from being defective.

In addition, in the flight imaging apparatus 1 according to the present embodiment, in the feature determination processing in the processor 46, the predetermined condition is a condition in which the feature point number N is equal to or less than the threshold value t. Accordingly, in comparison with a case where the predetermined condition is set each time in the feature determination processing, in the present configuration, a processing speed of the feature determination processing is improved.

In addition, in the flight imaging apparatus 1 according to the present embodiment, in the threshold value table 82, the threshold value t is determined in advance according to the type of the imaging target 2. Thus, the accuracy of the determination for sorting out the image as the target of the frequency emphasis processing is improved. As a result, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

For example, in comparison with a case where the threshold value t is constantly a constant value, in the present configuration, the threshold value t is determined in advance according to the type of the imaging target 2. Thus, the determination for sorting out the image as the target of the frequency emphasis processing is performed based on the threshold value t corresponding to the type of the imaging target 2. That is, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

In the flight imaging apparatus 1 according to the present embodiment, the frequency emphasis processing in the emphasis processing unit 68 is the convolution operation using the mask filter 68A. Thus, the contour of the unevenness indicated by the generation target images 92 and 94 and/or the change in color is emphasized, and the feature point number N is increased as compared with the feature point number N before the processing. As a result, the matching of the first feature information 92B and the second feature information 94B between the images used for the generation is accurately performed. Accordingly, with the present configuration, in the generation of the composite image 90, the composite image 90 is prevented from being defective.

In the flight imaging apparatus 1 according to the present embodiment, the composite image 90 generated by the processor 46 is the two-dimensional image 90A. Accordingly, with the present configuration, in the generation of the two-dimensional image 90A, the composite image 90 is prevented from being defective.

It should be noted that, in the above-described embodiment, although the form example in which the first feature information 92B and the second feature information 94B indicate the feature point numbers N included in the overlap image regions 95A and 95B has been described, the disclosed technology is not limited thereto. For example, the first feature information 92B and the second feature information 94B may indicate a density of the feature points included in the overlap image regions 95A and 95B.

In addition, the first feature information 92B and the second feature information 94B may indicate values obtained by using an operation expression in which the feature point number N is an independent variable, instead of indicating the feature point number N itself. In addition, the first feature information 92B and the second feature information 94B may indicate the dispositions of the feature points 92A and 94A (for example, a geometrical positional relationship between the feature points 92A in the generation target image 92 and a geometrical positional relationship between the feature points 94A in the generation target image 94) instead of indicating the feature point number N.

In addition, in the above-described embodiment, although the form example in which the threshold value t is obtained by the acquisition unit 65 by using the threshold value table 82 has been described, the disclosed technology is not limited thereto. For example, in the acquisition unit 65, the threshold value t may be obtained by using an operation expression in which a numerical value indicating the imaging target 2 is an independent variable and the threshold value t is an independent variable.

### Modification Example 1

In the above-described embodiment, although the form example in which the convolution operation using the mask filter 68A is performed, as the frequency emphasis processing in the emphasis processing unit 68 has been described, the disclosed technology is not limited thereto. In Modification Example 1, processing including performing the Fourier transform on the target image data 91 and performing the inverse Fourier transform on data from which noise is removed based on the result of the Fourier transform is performed as the frequency emphasis processing.

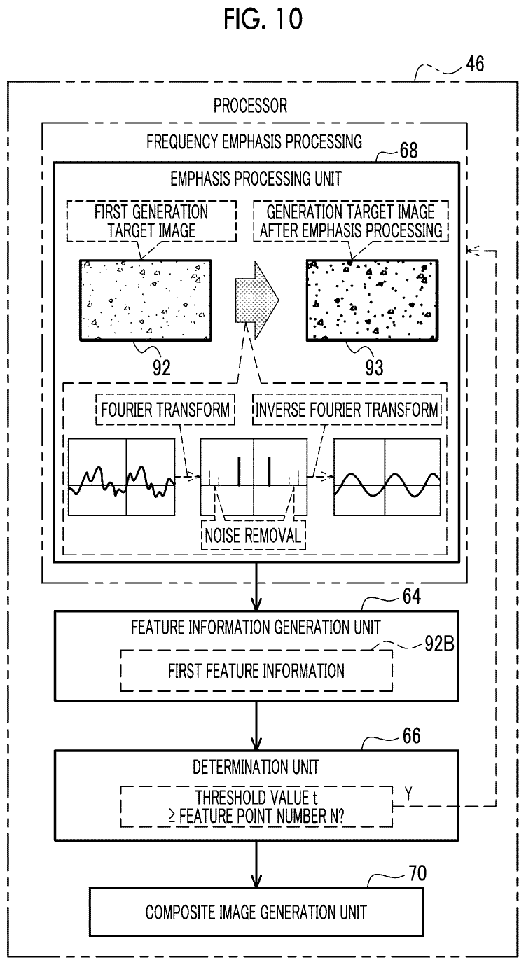

For example, as illustrated in FIG. 10, the emphasis processing unit 68 performs the frequency emphasis processing on the generation target image 92. In the example illustrated in FIG. 10, the Fourier transform is performed on the target image data 91 indicating the generation target image 92 by the emphasis processing unit 68. Further, the low-frequency component, which is the noise, is removed from the result of the Fourier transform. Finally, the inverse Fourier transform is performed on the data from which the noise has been removed. As a result, the generation target image 93 after the frequency emphasis processing is obtained. The emphasis processing unit 68 outputs the generation target image 93 after the frequency emphasis processing to the feature information generation unit 64.

The feature information generation unit 64 generates the first feature information 92B based on the generation target image 93. The determination unit 66 determines whether or not the first feature information 92B satisfies the predetermined condition by comparing the feature point number N1 indicated by the first feature information 92B with the threshold value t. In a case where the feature point number N1 indicated by the first feature information 92B is equal to or less than the threshold value t, the determination unit 66 determines that the predetermined condition is satisfied, and the feature determination processing (see FIG. 6) proceeds to the frequency emphasis processing again.

On the other hand, in a case where the feature point number N1 indicated by the first feature information 92B is more than the threshold value t, the determination unit 66 determines that the predetermined condition is not satisfied. In this case, the feature determination processing transitions to the image combining processing (FIG. 9) in the composite image generation unit 70.

As described above, in the flight imaging apparatus 1 according to Modification Example 1, the frequency emphasis processing in the emphasis processing unit 68 is processing including performing the Fourier transform on the target image data 91 and performing the inverse Fourier transform on the data from which the noise is removed based on the result of the Fourier transform. Thus, the contour of the unevenness indicated by the generation target images 92 and 94 and/or the change in color is emphasized, and the feature point number N is increased as compared with the feature point number N before the processing. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

### Modification Example 2

In the above-described embodiment, although the form example in which the imaging target information 80 includes the type of the imaging target 2 and the threshold value table 82 has, as the output value, the threshold value t corresponding to the imaging target 2 has been described, the disclosed technology is not limited thereto. In Modification Example 2, the imaging target information 80 includes information indicating a color, a material, and a surface state of the imaging target 2 in addition to the type of the imaging target 2.

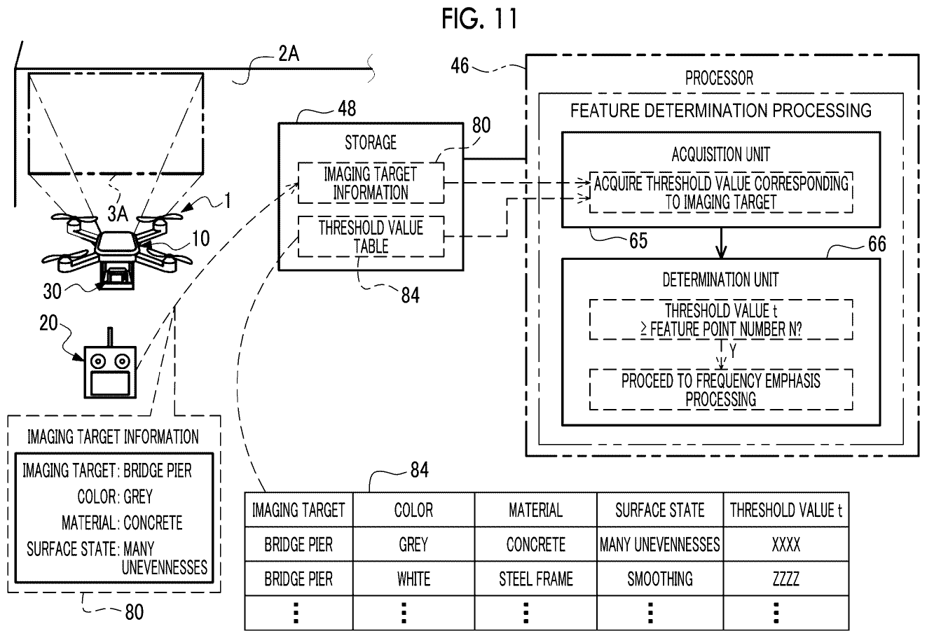

For example, as illustrated in FIG. 11, the flying object 10 receives the imaging target information 80 transmitted from the transmitter 20 in response to an operation by the user, and stores the imaging target information 80 in the storage 48. The imaging target information 80 includes information indicating the type of the imaging target 2 (for example, the imaging target 2 is the bridge pier), the color of the imaging target 2 (for example, grey), the material of the imaging target 2 (for example, concrete), and the surface state of the imaging target 2 (for example, unevenness or wetness). The unevenness referred to here includes, for example, unevenness associated with a defect and/or a deficiency in addition to unevenness due to a material forming the wall surface 2A.

The acquisition unit 65 acquires the imaging target information 80 from the storage 48. In addition, the acquisition unit 65 acquires the threshold value table 84 stored in advance in the storage 48. The threshold value table 84 is a table in which a numerical value indicating the type of the imaging target (for example, the bridge pier), a numerical value indicating the color, a numerical value indicating the material, and a numerical value indicating the surface state are used as input values and a threshold value t corresponding to each of the input values is used as an output value. The threshold value t is, for example, a numerical value indicating the number of feature points that enable the generation of the composite image 90 without the defect. The acquisition unit 65 acquires the threshold values t corresponding to the type of the imaging target 2, the color of the imaging target 2, the material of the imaging target 2, and the surface state of the imaging target 2 indicated by the imaging target information 80 by using the threshold value table 84.

The determination unit 66 compares the threshold value t with the feature point number N. In a case where the feature point number N is equal to or less than the threshold value t, the determination unit 66 determines that the predetermined condition is satisfied. In a case where it is determined in the determination unit 66 that the predetermined condition is satisfied, the feature determination processing proceeds to the frequency emphasis processing using the emphasis processing unit 68 (see FIG. 7).

As described above, in the flight imaging apparatus 1 according to Modification Example 2, the imaging target information 80 includes information indicating the type, the color, the material, and the surface state of the imaging target 2. It is determined whether or not the first feature information 92B and the second feature information 94B satisfy the predetermined conditions based on the information indicating the type, the color, the material, and the surface state of the imaging target 2. Thus, the accuracy of the determination for sorting out the image as the target of the frequency emphasis processing is improved. As a result, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

For example, in comparison with a case where the imaging target information 80 includes only the type of the imaging target 2, in Modification Example 2, the imaging target information 80 includes information indicating the type, the color, the material, and the surface state of the imaging target 2. Thus, the determination for sorting out the image as the target of the frequency emphasis processing is performed based on the type, the color, the material, and the surface state of the imaging target 2. That is, the frequency emphasis processing is accurately performed. The frequency emphasis processing is performed, and thus, the matching of the first feature information 92B and the second feature information 94B between the images used for the generation is accurately performed. Accordingly, with the present configuration, in the generation of the composite image 90, the composite image 90 is prevented from being defective.

It should be noted that, in the present modification example, although the form example in which the imaging target information 80 includes information indicating the type of the imaging target 2, the color of the imaging target 2, the material of the imaging target 2, and the surface state of the imaging target 2 has been described, the disclosed technology is not limited thereto. For example, the imaging target information 80 may be any one or any two combinations of the type of the imaging target 2, the color of the imaging target 2, the material of the imaging target 2, or the surface state of the imaging target 2. In addition, the imaging target information 80 may be any three combinations of the type of the imaging target 2, the color of the imaging target 2, the material of the imaging target 2, or the surface state of the imaging target 2.

### Modification Example 3

In the above-described embodiment, although the form example in which the parameter used in the frequency emphasis processing is determined in advance in the frequency emphasis processing has been described, the disclosed technology is not limited thereto. In Modification Example 3, the parameter in the frequency emphasis processing is set according to the imaging target 2.

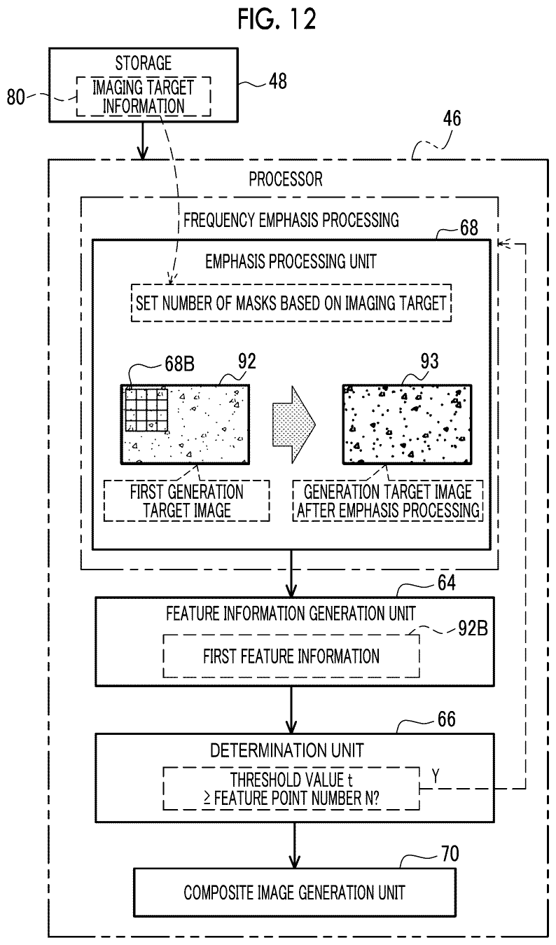

For example, as illustrated in FIG. 12, the emphasis processing unit 68 acquires the imaging target information 80 from the storage 48. The emphasis processing unit 68 sets the parameter in the frequency emphasis processing based on the imaging target information 80. In the example illustrated in FIG. 12, the emphasis processing unit 68 performs a convolution operation using a mask filter 68B according to the type of the imaging target 2 indicated by the imaging target information 80. The emphasis processing unit 68 sets the number of mask filters 68B corresponding to the type of the imaging target 2. In the example illustrated in FIG. 12, the number of masks of the mask filter 68B is 4×4. The parameter in the frequency emphasis processing may be calculated, for example, by using an operation expression in which a numerical value indicating the type of the imaging target 2 is an independent variable and the parameter is a dependent variable, or may be directly input by the operation of the user via the transmitter 20. The number of masks of the mask filter 68B is an example of a “parameter” according to the disclosed technology.

The emphasis processing unit 68 performs, on the generation target image 92, the frequency emphasis processing, which is processing of removing the low-frequency component that is the noise and emphasizing the high-frequency component that is the feature point. The emphasis processing unit 68 outputs the generation target image 93 after the frequency emphasis processing to the feature information generation unit 64.

The feature information generation unit 64 generates the first feature information 92B based on the generation target image 93. The determination unit 66 determines whether or not the first feature information 92B satisfies the predetermined condition by comparing the feature point number N1 indicated by the first feature information 92B with the threshold value t. In a case where the feature point number N1 indicated by the first feature information 92B is equal to or less than the threshold value t, the determination unit 66 determines that the predetermined condition is satisfied, and the feature determination processing (see FIG. 6) proceeds to the frequency emphasis processing again.

On the other hand, in a case where the feature point number N1 indicated by the first feature information 92B is more than the threshold value t, the determination unit 66 determines that the predetermined condition is not satisfied. In this case, the feature determination processing transitions to the image combining processing (FIG. 9) in the composite image generation unit 70.

As described above, in the flight imaging apparatus 1 according to Modification Example 3, the parameter in the frequency emphasis processing is set according to the imaging target 2. Since the parameter used in the frequency emphasis processing is set according to the imaging target 2, the feature information used in the feature determination processing is optimized as compared with the feature information before the processing. Accordingly, with the present configuration, in comparison with a case where the feature information is not optimized, in the generation of the composite image 90, the composite image 90 is prevented from being defective.

### Modification Example 4

In the above-described embodiment, although the form example in which the composite image 90 is the two-dimensional image 90A has been described, the disclosed technology is not limited thereto. In Modification Example 4, the composite image 90 is a three-dimensional image 90B.

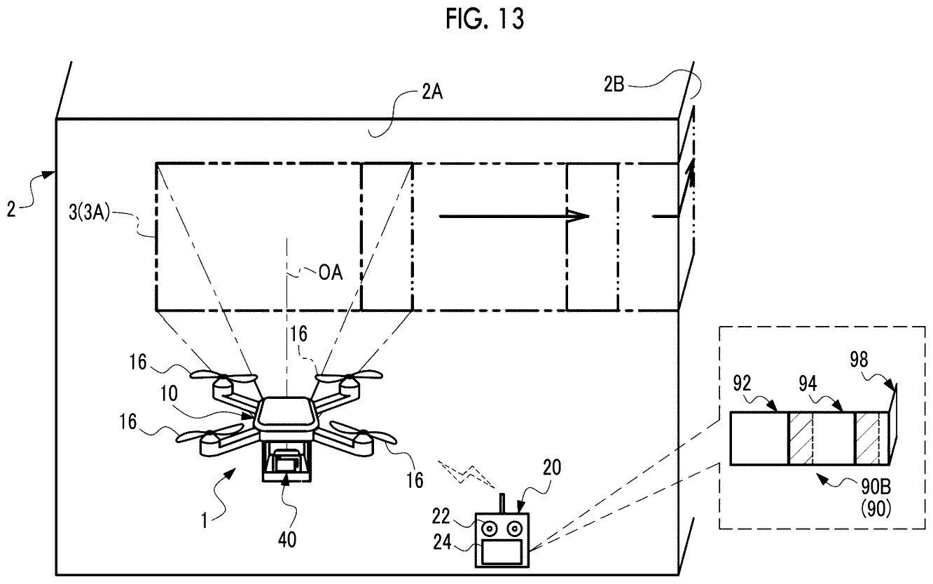

For example, as illustrated in FIG. 13, the flight imaging apparatus 1 images the plurality of regions 3 of the wall surface 2A in sequence. In addition, the flight imaging apparatus 1 images a plurality of regions 3 on a wall surface 2B continuous with the wall surface 2A. A plurality of generation target images 92, 94, and 98 are obtained by sequentially imaging the plurality of regions 3 with the imaging apparatus 30. The composite image 90 is generated by combining the plurality of generation target images 92, 94, and 98. The composite image 90 is a three-dimensional image 90B, which is an image indicating the imaging target 2. The three-dimensional image 90B is an example of a “three-dimensional image” according to the disclosed technology.

In the generation of the composite image 90, the determination unit 66 (see FIG. 5) performs the feature determination processing on the generation target images 92, 94, and 98. In a case where it is determined that the predetermined condition is satisfied in the feature determination processing, the emphasis processing unit 68 performs the frequency emphasis processing on a target image among the generation target images 92, 94, and 98. The composite image generation unit 70 performs the image combining processing on the generation target images 92, 94, and 98. As a result, the composite image 90 is generated.

As described above, in the flight imaging apparatus 1 according to Modification Example 4, the composite image 90 generated by the processor 46 is the three-dimensional image 90B. Accordingly, with the present configuration, in the generation of the three-dimensional image 90B, the composite image 90 is prevented from being defective.

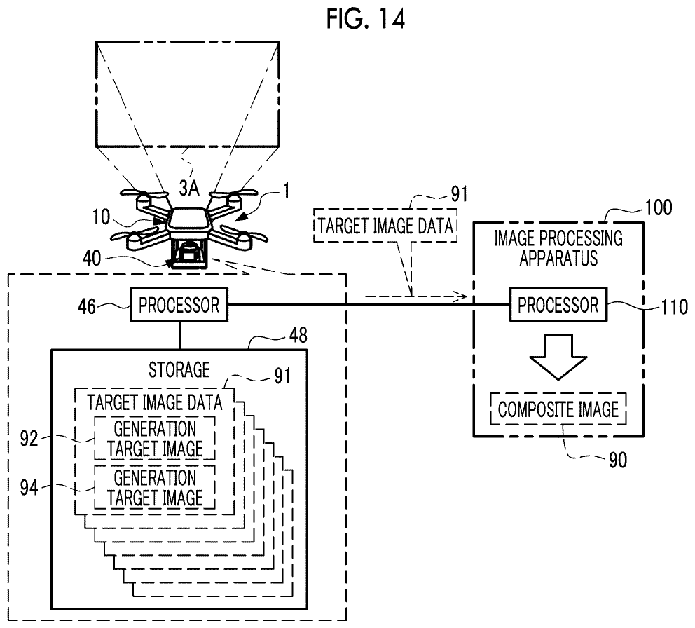

It should be noted that, in the above-described embodiment, although the form example in which the processor 46 of the flight imaging apparatus 1 generates the composite image 90 based on the target image data 91 stored in the storage 48 (see FIG. 8) has been described, the disclosed technology is not limited thereto. For example, as illustrated in FIG. 14, a processor 110 of an image processing apparatus 100 that is connected to communicate with the flight imaging apparatus 1 through wired connection or wireless connection may receive, as inputs, a plurality of pieces of target image data 91 from the processor 46 of the flight imaging apparatus 1, and the processor 110 of the image processing apparatus 100 may generate the composite image 90 based on the plurality of pieces of target image data 91. The image processing apparatus 100 is an example of an “image processing apparatus” according to the disclosed technology, and the processor 110 is an example of a “processor” according to the disclosed technology.

In addition, in the above-described embodiment, although the form example in which the images are imaged in a state where the optical axis OA is perpendicular has been described, the disclosed technology is not limited thereto. For example, the plurality of generation target images 92 and 94 used for the generation of the composite image 90 include an image on which projective transformation is performed. The image on which the projective transformation is performed refers to, for example, an image in which an image including an image region distorted into a trapezoid or the like due to a posture (for example, a depression angle or an elevation angle) of the imaging apparatus 30 is corrected. The projective transformation is processing performed on an image obtained by imaging the wall surface 2A with the imaging apparatus 30 in a state where the posture of the imaging apparatus 30 is inclined with respect to the wall surface 2A (that is, in a state where the optical axis OA of the imaging apparatus 30 is inclined with respect to the wall surface 2A).

The distortion of the image caused by the depression angle or the elevation angle is corrected by performing the projective transformation. That is, the image obtained by imaging the wall surface with the imaging apparatus 30 in a state where the posture of the imaging apparatus 30 is inclined with respect to the wall surface 2A is transformed like the image is obtained by the imaging from a position facing the wall surface 2A by performing the projective transformation.

In addition, in the above-described embodiment, although the form example in which the imaging target 2 is input by an operation of the user and the imaging target information 80 indicating the imaging target 2 is transmitted via the transmitter 20 has been described, the disclosed technology is not limited thereto. For example, the imaging target 2 included in the generation target images 92 and 94 as the images may be specified by performing image analysis on the generation target images 92 and 94 by the AI method or the pattern matching method.

In addition, in the above-described embodiment, although the form example is described in which the flight imaging apparatus 1 performs the flight and the imaging based on the flight instruction signal and the imaging start signal from the transmitter 20 has been described, the disclosed technology is not limited thereto. For example, the flight imaging apparatus 1 may perform the flight and the imaging according to a predetermined flight plan.

In addition, in the above-described embodiment, although the example in which the imaging apparatus 30 is mounted on the flying object 10 has been described, the imaging apparatus 30 may be mounted on various moving objects (for example, a gondola, an automatic transport robot, an unmanned transport vehicle, or a high-altitude inspection vehicle). In addition, the moving object may be a person. Here, the person refers to, for example, a worker who performs survey and/or inspection for land and/or infrastructure, or the like. It should be noted that, a case where the imaging apparatus 30 is mounted in a case where the moving object is the person includes an aspect in which the imaging apparatus 30 (for example, a mobile terminal with a camera function) is gripped by the person and/or the imaging apparatus 30 is attached to equipment worn by the person (for example, a helmet or a work wear).

In addition, in the above-described embodiment, although the form example in which the generation target images 92 and 94 are imaged as separate images has been described, the disclosed technology is not limited thereto. For example, the generation target images 92 and 94 may be obtained by being cut out from a motion picture obtained by imaging the imaging target 2 with the imaging apparatus 30.

In addition, in each of the above-described embodiments, although the processor 46 has been illustrated, at least one other CPU, at least one GPU, and/or at least one TPU may be used instead of the processor 46 or together with the processor 46.

In addition, in each of the above-described embodiments, although the form example in which the image processing program 60 is stored in the storage 48 has been described, the disclosed technology is not limited thereto. For example, the image processing program 60 may be stored in a portable non-transitory computer-readable storage medium such as an SSD or a USB memory (hereinafter, simply referred to as a “non-transitory storage medium”). The image processing program 60 stored in the non-transitory storage medium is installed in the computer 32 of the imaging apparatus 30, and the processor 46 executes processing according to the image processing program 60.

In addition, the image processing program 60 may be stored in a storage device such as another computer or a server device connected to the imaging apparatus 30 via a network, and the image processing program 60 may be downloaded in response to a request from the imaging apparatus 30 and may be installed in the computer 32.

In addition, the entire image processing program 60 may not be stored in the storage device such as the other computer, the server, or the like connected to the imaging apparatus 30 or in the storage 48, and a part of the image processing program 60 may be stored.

In addition, although the computer 32 is built in the imaging apparatus 30, the disclosed technology is not limited thereto, and for example, the computer 32 may be provided outside the imaging apparatus 30.

In addition, in each of the above-described embodiments, although the computer 32 including the processor 46, the storage 48, and the RAM 50 has been illustrated, the disclosed technology is not limited thereto, and a device including an ASIC, an FPGA, or a PLD may be applied instead of the computer 32. In addition, a combination of a hardware configuration and a software configuration may be used instead of the computer 32.

In addition, the following various processors can be used as hardware resources for executing various kinds of processing described in each of the above-described embodiments. Examples of the processor include a CPU which is a general-purpose processor functioning as the hardware resource for executing the various kinds of processing by executing software, that is, a program. In addition, examples of the processor include a dedicated electronic circuit which is a processor having a circuit configuration designed to be dedicated for executing specific processing, such as the FPGA, the PLD, or the ASIC. A memory is built in or connected to any processor, and any processor also executes various kinds of processing by using the memory.

The hardware resource for executing various kinds of processing may be one of various processors or may be a combination of two or more processors that are the same type or different types (for example, combination of a plurality of FPGAs or combination of a CPU and an FPGA). In addition, the hardware resource for executing various kinds of processing may be one processor.

As an example in which the hardware resource is one processor, first, there is a form in which one processor is a combination of one or more CPUs and software and this processor functions as the hardware resource for executing various kinds of processing. Secondly, as represented by SoC, there is a form in which a processor that realizes functions of the entire system including a plurality of hardware resources for executing various kinds of processing with one IC chip is used. As described above, various kinds of processing are realized by using one or more of various processors as the hardware resource.

Further, as a hardware structure of these various processors, more specifically, it is possible to use an electronic circuit in which circuit elements, such as semiconductor elements, are combined. Further, the above-described processing is merely an example. Accordingly, it is needless to say that unnecessary steps may be deleted, new steps may be added, or the processing order may be changed within a range that does not deviate from the gist.

The above-described contents and the above-illustrated contents are detailed descriptions for parts according to the disclosed technology, and are merely examples of the disclosed technology. For example, the above description related to configurations, functions, actions, and effects is description related to an example of the configurations, functions, actions, and effects of the parts related to the disclosed technology. Accordingly, it is needless to say that unnecessary parts may be deleted, new elements may be added, or replacements may be made with respect to the description contents and the illustrated contents above within a range that does not deviate from the gist of the disclosed technology. In addition, in order to avoid confusion and facilitate understanding of the parts related to the disclosed technology, description related to common technical knowledge and the like that do not require particular description to enable implementation of the disclosed technology is omitted from the contents described and illustrated above.

In the present specification, “A and/or B” is synonymous with “at least one of A or B”. In other words, “A and/or B” means that only A may be used, only B may be used, or a combination of A and B may be used. In addition, in the present specification, in a case where three or more matters are associated and expressed by “and/or”, the same concept as “A and/or B” is applied.

All documents, patent applications, and technical standards described in the present specification are incorporated by reference into the present specification to the same extent as in a case where the individual documents, patent applications, and technical standards were specifically and individually stated to be incorporated by reference.

The disclosure of JP2022-043029 filed on Mar. 17, 2022 is incorporated in the present specification by reference in its entirety.

What is claimed is:

1. An image processing apparatus comprising a processor,
wherein the processor is configured to:
make a determination whether or not imaging targets are included in generation target images used for generation of a composite image among a plurality of images obtained by imaging the imaging targets from a plurality of positions and feature information required for the generation satisfies a predetermined condition; and
perform frequency emphasis processing on the generation target images in a case where the feature information satisfies the predetermined condition, and
wherein the determination and the frequency emphasis processing are iterated until the feature information does not satisfy the predetermined condition.

2. The image processing apparatus according to claim 1,
wherein the processor is configured to determine whether or not the feature information satisfies the predetermined condition based on imaging target information, which is information related to a characteristic of the imaging target.

3. The image processing apparatus according to claim 2,
wherein the imaging target information includes information indicating a type, a color, a material, and/or a surface state of the imaging target.

4. The image processing apparatus according to claim 1,
wherein the feature information includes a first value based on the number of feature points included in the generation target image.

5. The image processing apparatus according to claim 2,
wherein the feature information includes a first value based on the number of feature points included in the generation target image.

6. The image processing apparatus according to claim 3,
wherein the feature information includes a first value based on the number of feature points included in the generation target image.

7. The image processing apparatus according to claim 4,
wherein the first value is the number of feature points included in an image indicating an overlap region, which is a region in which parts of the imaging targets overlap in the generation target image, or a density of the feature points.

8. The image processing apparatus according to claim 4,
wherein the predetermined condition is a condition in which the first value is equal to or less than a second value, which is a predetermined value.

9. The image processing apparatus according to claim 7,
wherein the predetermined condition is a condition in which the first value is equal to or less than a second value, which is a predetermined value.

10. The image processing apparatus according to claim 8,
wherein the second value is determined according to the imaging target.

11. The image processing apparatus according to claim 1,
wherein the frequency emphasis processing is processing including a convolution operation using a mask filter.

12. The image processing apparatus according to claim 1,
wherein the frequency emphasis processing is processing including performing Fourier transform and performing inverse Fourier transform on data from which noise is removed based on a result of the Fourier transform.

13. The image processing apparatus according to claim 1,
wherein a parameter used in the frequency emphasis processing is set according to the imaging target.

14. The image processing apparatus according to claim 1,
wherein the processor is configured to determine whether or not the feature information satisfies the predetermined condition under a condition in which a signal indicating a start instruction is input, and
the start instruction is received by a reception device.

15. The image processing apparatus according to claim 1,
wherein the composite image includes a two-dimensional image and/or a three-dimensional image.

16. An image processing method comprising:
making a determination whether or not imaging targets are included in generation target images used for generation of a composite image among a plurality of images obtained by imaging the imaging targets from a plurality of positions and feature information required for the generation satisfies a predetermined condition; and
performing frequency emphasis processing on the generation target images in a case where the feature information satisfies the predetermined condition,
wherein the determination and the frequency emphasis processing are iterated until the feature information does not satisfy the predetermined condition.

17. A non-transitory computer-readable storage medium storing a program that causes a computer to execute a process of:
making a determination whether or not imaging targets are included in generation target images used for generation of a composite image among a plurality of images obtained by imaging the imaging targets from a plurality of positions and feature information required for the generation satisfies a predetermined condition; and
performing frequency emphasis processing on the generation target images in a case where the feature information satisfies the predetermined condition,
wherein the determination and the frequency emphasis processing are iterated until the feature information does not satisfy the predetermined condition.
